(19) United States
(12) Patent Application Publication
(10) Pub. No.: US 2009/0024784 A1
(43) Pub. Date: Jan. 22, 2009

(54) METHOD FOR WRITING DATA INTO STORAGE ON CHIP AND SYSTEM THEREOF

(76) Inventors: Liang-Yun Wang, Taipei City (TW); Yao-Dun Chang, Hsinchu City (TW); Ming-Yang Chao, Hsin-Chu Hsien (TW); Ping-Sheng Chen, Chiayi County (TW)

Correspondence Address: NORTH AMERICA INTELLECTUAL PROPERTY CORPORATION, P.O. BOX 506, MERRIFIELD, VA, 22116, US

(21) Appl. No.: 11/780,490

(22) Filed: Jul. 20, 2007

(51) Int. Cl. G06F 12/00

(52) U.S. Cl. 711/100; 711/E12.001

(57) ABSTRACT

Disclosed are a method for writing data into a first storage on a chip and a system thereof. The method includes storing an initial firmware into a second storage on the chip, programming the first storage according to a specific data by utilizing the initial firmware, and blocking further programming operations applied to at least part of the specific data after the specific data is successfully stored in the first storage. Therefore the invention can save the external pin connections of the chip to prevent computer hackers from accessing or changing the content of the storage.

### BACKGROUND

The invention relates to a method for writing data into storage on a chip and a system thereof, and more particularly, to a method for writing eFuse data into a first storage on a chip utilizing a firmware, and a system thereof.

Digital Right Management (DRM) focuses on security and encryption as a means of solving the issue of unauthorized copying of data; that is, securing the content and limiting its distribution to only those people who pay. Therefore, DRM usually requires an electronic device to be provided with a unique certificate and a corresponding secrete key. A conventional method records the secrete key in an on-chip one-time-programmable storage, such as an eFuse of the device, through external pin connections. For example, the secrete key is programmed into the on-chip one-time-programmable storage at the IC testing machine or assembly line through the external pin connections of the chip. Recording the secrete key through external pin connections, however, exposes the secrete key to the external environment and may cause data security leaks, since it is highly possible that hackers try to extract the secrete key from the storage through the external pin connections. In general, because the secrete key is not protected by any encryption means during the product manufacturing process, there is a risk of the secrete key being stolen by operators operating the IC testing machine or the assembly line.

### SUMMARY

One objective of the invention is to provide a method for writing data (e.g. eFuse data) into a storage on a chip by utilizing a firmware stored in another storage on the chip, and a system thereof to save the external pin connections and prevent computer hackers from accessing or changing the content of the storage (for example, the secrete key burnt in the eFuse) utilizing some external tools.

According to an exemplary embodiment of the present invention, a method for writing data into a first storage on a chip comprises storing an initial firmware into a second storage on the chip; programming the first storage according to a specific data by utilizing the initial firmware; and after the specific data is successfully stored in the first storage, blocking further programming operations applied to at least part of the specific data.

According to an exemplary embodiment of the present invention, a system for data programming comprises a first storage on a chip; a second storage on the chip, for storing an initial firmware; and a control module, coupled to the first storage and the second storage, for programming the first storage according to a specific data by utilizing the initial firmware, and after the specific data is successfully stored in the first storage, blocking further programming operations applied to at least part of the specific data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a system for data programming of on-chip storages according to an exemplary embodiment of the present invention.

FIG. 2 is a flow chart illustrating an operation of programming on-chip storages according to an embodiment of the present invention.

FIG. 3 is a flow chart illustrating an operation of programming on-chip storages according to another embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

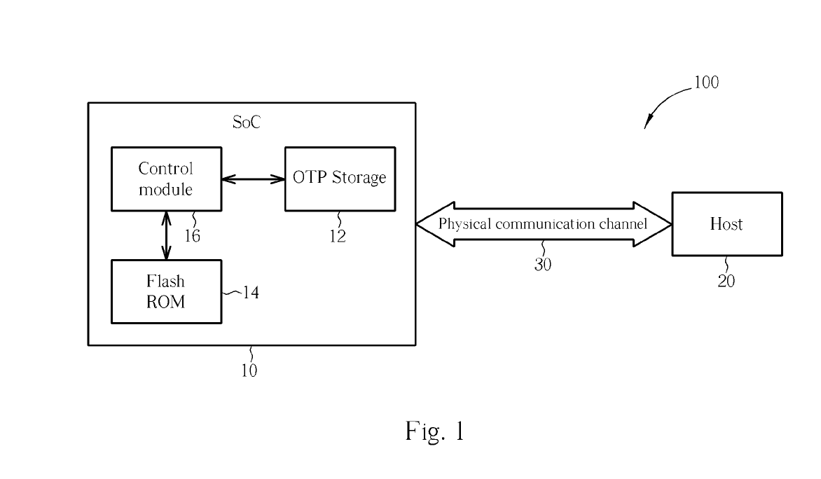

In order to save the pin connections of a chip and prevent computer hackers from accessing or changing the content of the on-chip one-time-programmable storage (e.g. the eFuse) externally, the present invention utilizes a firmware to program the storage according to a specific data and then blocks further programming operations applied to at least part of the specific data after the specific data is successfully stored. FIG. 1 shows a block diagram of a system for data programming of on-chip storages according to an exemplary embodiment of the present invention. As shown in FIG. 1, the system 100 includes a system-on-chip (SoC) 10 and a host 20, where the SoC and the host 20 are connected through a physical communication channel 30 complying with an IDE or SATA specification. The SoC 10 includes a first on-chip storage, a second on-chip storage, and a control module 16 coupled to the first on-chip storage and the second on-chip storage, wherein these components are formed on the same chip. The control module 16 contains any hardware needed for controlling overall operation of the SoC 10. For example, in the embodiment shown in FIG. 1, the control module 16 comprises a microprocessor (not shown) for executing firmware of the SoC 10, such as the initial firmware and the production firmware mentioned in the following disclosure, and further comprises circuits (not shown) for programming and/or erasing the on-chip storages. Please note that only the components pertinent to the present invention are shown in FIG. 1 for simplicity. In this embodiment, the second on-chip storage is implemented by a flash ROM 14, and the first on-chip storage is implemented by a one-time-programmable (OTP) storage 12; however, this is for illustrative purposes only, and not meant to be a limitation of the present invention. For example, in other embodiments of the present invention, the flash ROM 14 can be replaced by any other re-programmable storage.

In this embodiment, the flash ROM 14 is configured to store at least an initial firmware, and the control module 16 programs the OTP storage 12 according to a specific data by utilizing the initial firmware read from the flash ROM 14. After the specific data is successfully stored in the OTP storage 12, the control module 16 blocks further programming operations applied to at least part of the specific data stored in the OTP storage 12. In other words, when the specific data is written into the OTP storage 12, bits in the OTP storage 12 are programmed or remain intact according to 1's and 0's of the specific data. Bits of the OTP storage 12 remaining un-programmed after the specific data is stored can still be programmed, however, the currently described exemplary embodiment will avoid doing this by using protection schemes, which are detailed later.

The system 100 is capable of being utilized to record a secrete key in an eFuse on a device, where the first on-chip storage (i.e. the OTP storage 12) is regarded as an eFuse and the specific data is an eFuse data corresponding to the secrete key for decrypting and/or verifying a production firmware of the SoC 10. An optical disc drive is taken as an example, meaning that the SoC 10 is disposed on an optical disc drive and the host 20 is a personal computer or the like. Since the eFuse data is utilized for decrypting and/or verifying firmware, the initial firmware (or called initial firmware image) is encrypted or signed with a default key setting. In this embodiment, the default key setting is embedded in the SoC 10. For example, the control module 16 is designed to include the default key setting for decrypting and/or verifying the encrypted initial firmware; or the initial contents of the OTP storage 12, which have not been programmed yet, are referred to as the default key setting, i.e., all of the bits in the OTP storage 12 store the same initial logic value (either “0” or “1”). In the beginning, the flash ROM 14 has no firmware stored therein, and no firmware updating is available. Therefore, the initial firmware is stored into the flash ROM 14 by any known means. For example, pin connections are used to store the initial firmware into the flash ROM 14.

The initial firmware itself may comprise the specific data, or the host 20 additionally sends the specific data to the SoC 10 after the initial firmware is running, depending upon design requirements. In order to minimize the risk of information leaks, the host 20 encrypts the specific data before it is delivered to the SoC 10. In one case where the specific data is included in the initial firmware, the specific data is encrypted as the initial firmware is encrypted by the default key setting. After the encrypted initial firmware is stored into the flash ROM 14, the SoC 10 is booted. Next, the control module 16 verifies and decrypts the encrypted initial firmware stored in the flash ROM 14 with the built-in default key setting to thereby obtain the initial firmware and the specific data included therein. If the integrity check is passed, the control module 16 starts running the initial firmware. When the SoC 10 receives a host command from the host 20 via the physical communication channel 30, the control module 16 utilizes the initial firmware to program the OTP storage 12 (i.e., the eFuse) according to the currently available specific data, and optionally downloads a production firmware and other drive-specific data, such as the power curve of the optical disc drive, from the host 20 into the flash ROM 14. The host 20 encrypts the production firmware and other drive-specific data by key setting of the eFuse data before delivering the production firmware and other drive-specific data to the SoC 10. At the next reboot of the SoC 10, the programmed part of the eFuse 12 takes effect (it only takes effect after rebooting the SoC 10). The control module 16 verifies and decrypts the encrypted production firmware stored in the flash ROM 14 according to contents of the eFuse 12, and then executes the production firmware to perform the normal functionality defined in the SoC 10 if the integrity check is passed. The production firmware may further update itself according to a host command, which is well known to those skilled in the art.

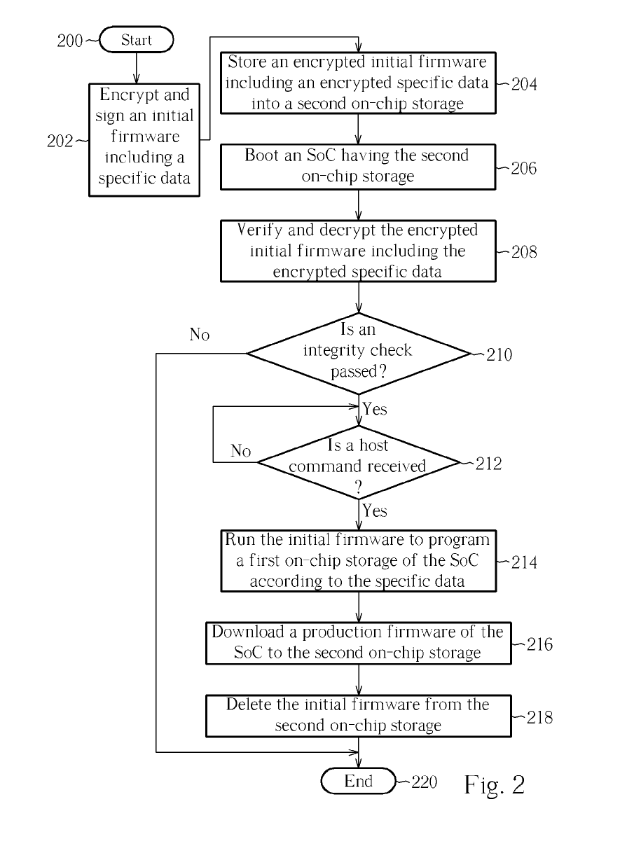

The above disclosure can be briefly summarized by a flow chart shown in FIG. 2. Provided the result is substantially the same, the steps in the flow are not limited to be executed according to the exact order shown in FIG. 2. The flow is executed by the system 100 shown in FIG. 1, and includes the following steps:
Step 200: Start.
Step 202: Encrypt and sign an initial firmware including a specific data with default key setting.
Step 204: Store an encrypted initial firmware including an encrypted specific data into a second on-chip storage.
Step 206: Boot an SoC having the second on-chip storage with the encrypted initial firmware stored therein.
Step 208: Verify and decrypt the encrypted initial firmware including the encrypted specific data.
Step 210: Is an integrity check passed? If yes, go to step 212; otherwise, go to step 220.
Step 212: Is a host command received? If yes, go to step 214; otherwise, execute step 212 to keep monitoring.
Step 214: Run the initial firmware to program a first on-chip storage of the SoC according to the specific data.
Step 216: Download a production firmware of the SoC to the second on-chip storage by the initial firmware or other available means.
Step 218: Delete the initial firmware from the second on-chip storage.
Step 220: End.

Since operations of the steps shown in FIG. 2 are detailed above, a skilled person can readily understand the flow after reading the above description. Further description is omitted here for brevity.

In another case where the specific data is not delivered along with the initial firmware, the SoC 10 is booted after the encrypted initial firmware is stored into the flash ROM 14, and then the control module 16 verifies and decrypts the encrypted initial firmware stored in the flash ROM 14 with the built-in default key setting to thereby obtain the initial firmware and the specific data included therein. If the integrity check is passed, the control module 16 starts running the initial firmware. When the SoC 10 receives a host command from the host 20 via the physical communication channel 30, the control module 16 receives an encrypted specific data from the host 20 via the physical communication channel 30, wherein the host 20 encrypts the specific data by a certain algorithm and secrete key, which are implemented in the control module 16 or the initial firmware. After receiving the encrypted specific data, the control module 16 executes the initial firmware for decrypting the encrypted specific data to thereby obtain the specific data to be stored into the OTP storage. The control module 16 further runs the initial firmware to program the eFuse 12 according to the currently available specific data, and optionally downloads a production firmware and other drive-specific data, such as the power curve of the optical disc drive, from the host 20 into the flash ROM 14. The host 20 encrypts the production firmware and other drive-specific data by key setting of the eFuse data before delivering the production firmware and other drive-specific data to the SoC 10. At the next reboot of the SoC 10, the programmed part of the eFuse 12 takes effect (it only takes effect after rebooting the SoC 10). The control module 16 verifies and decrypts the production firmware stored in the flash ROM 14 according to contents of the eFuse 12, and then executes the production firmware to perform the normal functionality defined in the SoC 10 if the integrity check is passed. The production firmware may further update itself according to a host command, which is well known to those skilled in the art.

Although in the above embodiment, the control module 16 utilizes the initial firmware to download the production firmware before rebooting the system 10, the production firmware can be downloaded from the host 20 by other means. That is, any conventional means of programming the production firmware into the flash ROM 14 can be adopted. In short, in a preferred exemplary embodiment the initial firmware is implemented to program the eFuse data into the OTP storage 12 and the production firmware of the SoC 10 into the flash ROM 14. However, this is not meant to be a limitation of the present invention, and any systems using firmware to program eFuse data into the on-chip storage obey the spirit of the present invention, and fall within the scope of the present invention.

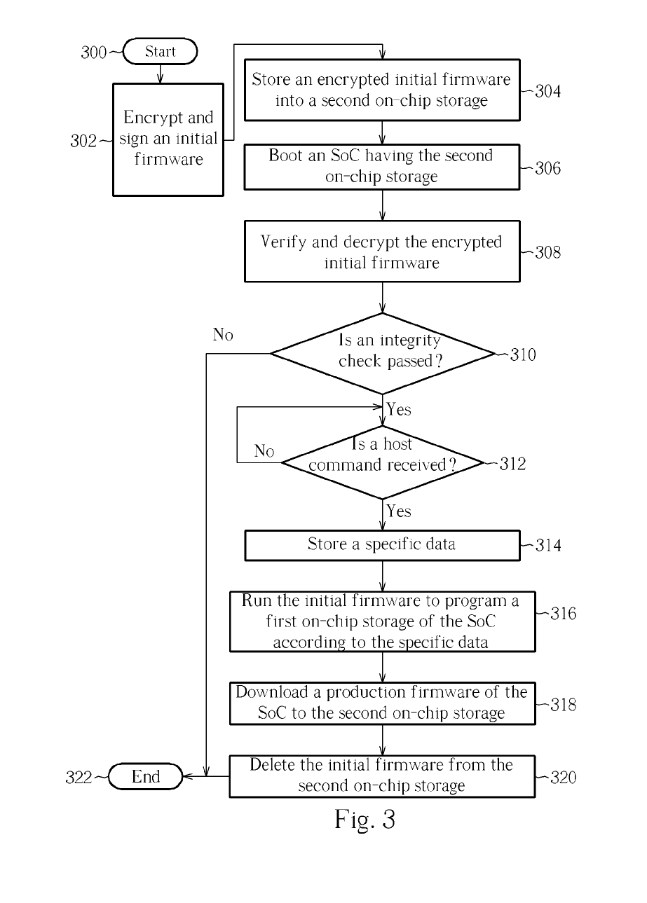

The above disclosure can be briefly summarized by a flow chart shown in FIG. 3. Provided the result is substantially the same, the steps in the flow are not limited to be executed according to the exact order shown in FIG. 3. The flow is executed by the system 100 shown in FIG. 1, and includes the following steps:
Step 300: Start.
Step 302: Encrypt and sign an initial firmware with default key setting.
Step 304: Store an encrypted initial firmware into a second on-chip storage.
Step 306: Boot an SoC having the second on-chip storage with the encrypted initial firmware stored therein.
Step 308: Verify and decrypt the encrypted initial firmware.
Step 310: Is an integrity check passed? If yes, go to step 312; otherwise, go to step 322.
Step 312: Is a host command received? If yes, go to step 314; otherwise, execute step 312 to keep monitoring.
Step 314: Store a specific data.
Step 316: Run the initial firmware to program a first on-chip storage of the SoC according to the specific data.
Step 318: Download a production firmware of the SoC to the second on-chip storage by the initial firmware or other available means.
Step 320: Delete the initial firmware from the second on-chip storage.
Step 322: End.

Since operations of the steps shown in FIG. 3 are detailed above, a skilled person can readily understand the flow after reading the above description. Further description is omitted here for brevity.

As can be seen, by arranging the default eFuse content to be some known default setting embedded in the SoC 10, the potential interference between the firmware and the eFuse content due to the eFuse controlling how the hardware verifies and decrypts the firmware is avoided. In short, with the implementation of the default eFuse content, the firmware encryption and integrity check can be combined without interference.

The process of the control module 16 programming the first storage 12 by utilizing the initial firmware is disclosed in the above description. The following discloses how the present invention protects the content of the OTP storage 12 from being further changed. After the specific data is successfully stored in the OTP storage 12, the control module 16 blocks the initial firmware from further modifying contents stored in the OTP storage 12 by deleting the initial firmware from the flash ROM 14. If there is no initial firmware, consumers or hackers will have difficulty destroying the security protection of the device to copy or change the content of the OTP storage 12. Therefore, the secrete key stored in the eFuse (i.e. the OTP storage 12) can be properly protected. Moreover, due to the inherent characteristics of the OTP storage 12, any bit of the OTP storage 12 can be altered (programmed) only once. A protection bit or bit combination can be set to block un-programmed bits in the first on-chip storage (i.e. the OTP storage 12) from being programmed if the specific data (i.e. the eFuse data) has been stored. When the hacker commands the control module 16 to alter contents of the OTP storage 12, the control module 16 can check this protection bit or bit combination to avoid entering the write mode for altering the un-programmed bits of the OTP storage 12. In an alternative design, the control module 16 can mask the write signal outputted to the OTP storage 12 to prevent the OTP storage 12 from being altered.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for writing data into a first storage on a chip, comprising:
storing an initial firmware into a second storage on the chip;
programming the first storage according to a specific data by utilizing the initial firmware; and
after the specific data is successfully stored in the first storage, blocking further programming operations applied to at least part of the specific data.

2. The method of claim 1, wherein the step of blocking further programming operations comprises:
blocking the initial firmware from modifying contents stored in the first storage.

3. The method of claim 2, wherein the step of blocking the initial firmware from modifying contents stored in the first storage comprises deleting the initial firmware from the second storage.

4. The method of claim 1, wherein the step of blocking further programming operations comprises:
setting a protection bit or bit combination to block the first storage from being programmed.

5. The method of claim 4, wherein the first storage is a one-time-programmable storage, and the protection bit or bit combination blocks un-programmed bits in the one-time-programmable storage from being programmed.

6. The method of claim 1, wherein the step of blocking further programming operations comprises:
masking a write signal outputted to the first storage.

7. The method of claim 1, wherein the step of storing the initial firmware comprises encrypting or signing the initial firmware with a default key setting to generate an encrypted initial firmware, and storing the encrypted initial firmware into the second storage; and the step of programming the first storage comprises: decrypting the encrypted initial firmware with the default key setting, and programming the first storage according to the specific data by utilizing the initial firmware.

8. The method of claim 1, wherein the step of programming the first storage further comprises:
receiving the specific data from a host through a physical communication channel.

9. The method of claim 8, wherein the chip is disposed on an optical disc drive, and the physical communication channel complies with an IDE or SATA specification.

10. The method of claim 8, wherein the step of programming the first storage further comprises:
encrypting the specific data by the host to generate an encrypted specific data before the specific data is delivered to the chip; and
decrypting the encrypted specific data by the initial firmware when the chip receives the encrypted specific data from the host.

11. The method of claim 1, wherein the specific data is embedded in the initial firmware.

12. The method of claim 1, wherein the specific data is an eFuse data for decrypting or verifying a production firmware of the chip, and the method further comprises:
storing the production firmware into the second storage.

13. The method of claim 12, wherein the step of storing the production firmware comprises utilizing the initial firmware to store the production firmware into the second storage.

14. A method for writing data into a first storage on a chip, comprising:
storing an initial firmware into a second storage on the chip; and
programming the first storage according to an eFuse data by utilizing the initial firmware.

15. A system for data programming, comprising:
a first storage, formed on a chip;
a second storage, formed on the chip, for storing an initial firmware; and
a control module, formed on the chip and coupled to the first storage and the second storage, for programming the first storage according to a specific data by utilizing the initial firmware, and after the specific data is successfully stored in the first storage, blocking further programming operations applied to at least part of the specific data.

16. The system of claim 15, wherein the control module blocks further programming operations by blocking the initial firmware from modifying contents stored in the first storage.

17. The system of claim 16, wherein the control module blocks the initial firmware from modifying contents stored in the first storage by deleting the initial firmware from the second storage.

18. The system of claim 15, wherein the control module blocks further programming operations by setting a protection bit or bit combination to block the first storage from being programmed.

19. The system of claim 18, wherein the first storage is a one-time-programmable storage, and the protection bit or bit combination blocks un-programmed bits in the one-time-programmable storage from being programmed.

20. The system of claim 15, wherein the control module blocks further programming operations by masking a write signal outputted to the first storage.

21. The system of claim 15, wherein the initial firmware is encrypted or signed with a default key setting to be an encrypted initial firmware; and the control module decrypts the encrypted initial firmware with the default key setting, and programs the first storage according to the specific data by utilizing the initial firmware.

22. The system of claim 15, further comprising a host coupled to the chip through a physical communication channel;
wherein the specific data is received from the host through the physical communication channel.

23. The system of claim 22, wherein the chip is disposed on an optical disc drive, and the physical communication channel complies with an IDE or SATA specification.

24. The system of claim 22, wherein the specific data is encrypted by the host to generate an encrypted specific data before the specific data is delivered to the chip; and the initial firmware decrypts the encrypted specific data when the chip receives the encrypted specific data from the host.

25. The system of claim 15, wherein the specific data is embedded in the initial firmware.

26. The system of claim 15, wherein the specific data is an eFuse data for decrypting or verifying a production firmware of the chip, and the production firmware is stored in the second storage.

27. The system of claim 26, wherein the control module utilizes the initial firmware to store the production firmware into the second storage.

28. A system for data programming, comprising:
a first storage, formed on a chip;
a second storage, formed on the chip, for storing an initial firmware; and
a control module, formed on the chip and coupled to the first storage and the second storage, for programming the first storage according to an eFuse data by utilizing the initial firmware.
